(19) United States
(12) Patent Application Publication
(10) Pub. No.: US 2011/0132347 A1
(43) Pub. Date: Jun. 9, 2011

(54) PORTABLE CHARCOAL GRILL

(76) Inventor: Kyoung Hwan Kim, Gyeonggi-do (KR)

(21) Appl. No.: 12/670,324

(22) PCT Filed: Jul. 24, 2008
(86) PCT No.: PCT/KR2008/004333

§ 371 Date: May 4, 2010

(30) Foreign Application Priority Data
Jul. 25, 2007 (KR) 10-2007-0074368
Feb. 4, 2008 (KR) 10-2008-0011194

(51) Int. Cl. A47J 37/07

(52) U.S. Cl. 126/25 R

(57) ABSTRACT

A portable charcoal grill is disclosed which places charcoal on an internal support mesh located at the bottom of the housing thereof. The portable charcoal grill includes: a fixing string (50) having a certain length whose lower end forms a middle bent portion (53) that is vertically fitted into part of the internal support mesh (20) at which the charcoal is placed, and whose upper end is widened to fix the charcoal; charcoal (4) each of which has a through-hole (4-1) through which the fixing string (50) is extended and has a height such that the fixing string (50) is protruded from top thereof; and a wire roasting mesh (3) placed on the fixed charcoal (4).

### TECHNICAL FIELD

The present invention relates to charcoal grills. More particularly, this invention relates to a portable charcoal grill that vertically fixes charcoal to the internal support mesh by fixing strings in such a way that the middle portion of each fixing string is fixed to the internal support mesh and both ends of the fixing string are extended through the through-hole of the charcoal and then widened and bent horizontally at the upper end of the charcoal, so that the bent fixing string supports the wire roasting mesh and objects to be roasted. Therefore, the portable charcoal grill does not require any additional mesh to fix the charcoal to the internal support mesh. The height of portable charcoal grill can be reduced and this can prevent structural damage from occurring during loading, storing, or carrying.

### BACKGROUND ART

Conventional portable charcoal grills, as shown in FIGS. 1 and 2, are configured to include: a housing 2 whose side walls incline and widen at toward the top; an internal support mesh 10 having a side wall support mesh 11-1, supported by the side walls of the housing 2, and a lower support mesh 11, placed at the bottom of the housing 2, for supporting charcoal 4; a charcoal fixing mesh 5 for covering and placing the charcoal 4 on the lower support mesh 11; and a wire roasting mesh 3 that is placed on the upper end of the side wall support mesh 11-1 and forms a chamber thereunder between itself and the charcoal fixing mesh 5.

The housing 2 has a side wall 1 whose end forms a bent band 9 that is bent to support the edge of the wire roasting mesh 3. Ignition material 12 for igniting the charcoal 4 is placed between the lower support mesh 11 and the internal bottom surface of the housing 2. The charcoal support mesh 5 and the internal support mesh 10 are securely coupled to each other by a coupling member 13.

The side wall 1 of the housing 2 is inclined. The side wall support mesh 11-1 of the internal support mesh 10 is supported by the inclined side wall 1. Since the side wall 1 is made of a soft material, however, it does not attach the internal support mesh 10 at a certain location and instead is bent. This is problematic since the igniting material 12 is not easily inserted to the chamber. In particular, when the igniting material is inserted, the charcoal fixing mesh 5 must be moved, which accordingly causes the charcoal 4 to move.

FIG. 3 is a plan view illustrating a conventional charcoal grill.

The conventional charcoal grill is configured in such a way that a spacing maintaining mesh 40 is placed at the center portion of the charcoal grill; internal support meshes 20 are placed at both sides of the spacing maintaining mesh 40; ignition materials 12 are placed under the respective internal support meshes 20; and charcoal 4 is placed on the respective internal support meshes 20 and arranged in a plurality of columns (or rows), spaced from each other at a certain interval by charcoal fixing meshes 30. The charcoal fixing mesh 30 is formed in such a way that: a side support part 33 and an upper support part 32 which are bent to receive and fix charcoal in a plurality of columns; interval maintaining downward-protruding parts 35, whose bent height is similar to half of the charcoal height, for maintaining a interval between the columns of the charcoal; and protrusions 34 that are extended from the interval maintaining downward-protruding parts 35, i.e., the upper portion of the columns of the charcoal placed at the center portion, to a wire roasting mesh 3.

FIG. 4 is a cross-sectional view illustrating the charcoal grill, taken along line G-G, in FIG. 3.

As shown in FIG. 4, the internal support mesh 20 is placed on the bottom surface of the charcoal grill. The charcoal 4 are placed on the internal support mesh 20 in columns spaced apart from each other at a certain distance. A side support part 33 and an upper support part 32 are bent to receive and fix charcoal in a plurality of columns. Interval maintaining down-protruding parts 35 separate the columns of the charcoal 4 at a certain distance. Protrusions 34 are shaped to cover the upper part of the charcoal placed at the center portion and are extended from the interval maintaining downward-protruding parts 35 to the vertical direction.

FIG. 5 is a cross-sectional view illustrating the charcoal grill, taken along line H-H, in FIG. 3.

As shown in FIG. 5, an internal support mesh 20 is placed and supported between interval maintaining meshes 40. Ignition material 12 is placed in the internal support mesh 20. The internal support mesh 20 is placed on the side wall of the housing 2. The side wall of the housing 2 forms an opening 6. Charcoal 4 are placed on the internal support mesh 20 and placed upright at a certain height. The protrusions 34 wrap the sides of the charcoal 4 and at the same time support the wire roasting mesh 3.

Since the charcoal fixing mesh 30 is supported by the spacing maintaining meshes 40 which are separated from each other, all members are tightly assembled and charcoal is not moved. Since the charcoal is placed and arranged in columns in the housing, the conventional charcoal grill is advantageous to a roast item that needs to be cooked by relatively even heat. As shown in FIG. 4, the columns of charcoal 4 are arranged at a certain distance by the interval maintaining downward-protruding parts 35. Also, the charcoal fixing mesh 30 is formed to include protrusions 34 that extend upward from the columns of charcoal, placed at the center of the columns, to the wire roasting mesh 3. The protrusions 34 form protruding means for supporting the wire roasting mesh 3.

However, since the conventional charcoal grill is configured in such a way that its meshes are coupled to each other, its volume, height and width, increases and accordingly this causes an increase in manufacturing costs as well as an increase in freight charges and storage fees.

In addition, since the ignition material is placed in the bottom of the housing and then ignited, air cannot be continuously provided to the ignition material and accordingly the charcoal cannot burn evenly.

Furthermore, since the housing containing charcoal and meshes is made of relatively thin aluminum and accordingly suffers from vertical weakness, its shape can be distorted during movement and this breaks down the arrangement of the charcoal and lowers the product price.

### DISCLOSURE

### Technical Problem

The present invention solves the above problems, and provides a portable charcoal grill that can fix charcoal to the mesh by the use of through-holes of the charcoal, thereby providing a convenient method of charcoal fixing work and preventing ensuring efficient operation of the grill.

The present invention further provides a portable charcoal grill that can fix charcoal to the mesh, by using the pillars each of which is cut and formed as a band type from the internal support mesh, without the need for any additional means of charcoal fixing.

The present invention further provides a portable charcoal grill that includes an ignition material support mesh in a space formed by space forming legs on both sides of the internal support mesh, in which the ignition material support mesh supports an ignition material and provides air above and below the ignition material, thereby easily igniting the ignition material.

The present invention further provides a portable charcoal grill that repeatedly forms bent grooves on the side wall of the housing at a certain interval and thus increases the durability.

The present invention further provides a portable charcoal grill that forms a pushing portion that protrudes downwards at the middle portion of the internal support mesh, so that the pushing portion prevents the ignition material from moving from side to side and thus the ignition material provides even heat from the beginning.

The present invention further provides a portable charcoal grill configured in such a way that a charcoal fixing mesh fixes and covers charcoal, in which the charcoal fixing mesh forms interval maintaining parts to prevent the charcoal from moving from side to side and supports the wire roasting mesh, thereby reducing the space between the charcoal fixing mesh and the wire roasting mesh, accordingly reducing the whole height of the grill, and increasing its mobility and storage convenience.

The present invention further provides a portable charcoal grill that includes an ignition material support mesh that forms a charcoal underside space by space forming legs, located at both sides of the internal support mesh, supports an ignition material to be put in the charcoal underside space, and has passages for providing outside air the above and below the ignition material, thereby easily igniting the ignition material and continuously burning it.

The present invention further provides a portable charcoal grill that repeatedly forms bent grooves on the side wall of the housing at a certain interval and increases the vertical and horizontal strength of the side wall, thereby enhancing storage convenience, loading convenience, and durability to prevent structural damage.

The present invention further provides a portable charcoal grill that forms a pushing portion that protrudes downward at the middle portion of the internal support mesh, so that the pushing portion prevents the ignition material from moving from side to side and thus the ignition material provides concentrated and even heat from the beginning.

### Technical Solution

In accordance with a first aspect of the present invention, the present invention provides a portable charcoal grill that is configured in such a way to include fixing strings each of whose middle portion is fixed to the internal support mesh and each of whose both strings with respect to the middle portion are extended through the through-hole of the charcoal placed on the internal support mesh and then bent at the upper end of the charcoal to the side of charcoal, thereby supporting the charcoal, without altering the height.

In accordance with a second aspect of the present invention, the present invention provides a portable charcoal grill that places charcoal on an internal support mesh located at the bottom of the housing thereof, the portable charcoal grill including: a fixing string having a certain length, whose lower end is cut as a band-shape and vertically bent at a place of the internal support mesh, and whose upper end is horizontally bent to fix the charcoal; charcoal each of which has a through-hole through which the fixing string is extended and has a height such that the fixing string is protruded from the top thereof; and a wire roasting mesh placed on the fixed charcoal.

In accordance with a third aspect of the present invention, the present invention provides a portable charcoal grill that places charcoal on an internal support mesh located at the bottom of the housing thereof, the portable charcoal grill including: a fixing string having a certain length whose lower end forms a middle bent portion that is vertically fitted into part of the internal support mesh at which the charcoal is placed, and whose upper end is widened to fix the charcoal; charcoal each of which has a through-hole through which the fixing string is extended and has a height such that the fixing string is protruded from the top thereof; a wire roasting mesh placed on the fixed charcoal; space forming legs, integrally bent down to both sides of the internal support mesh, for generating a charcoal underside space between the internal support mesh and the bottom of the housing; and ignition material supporting mesh for supporting ignition material, wherein the ignition material supporting mesh is placed at half of the height of the charcoal underside space by the space forming legs and formed such that its middle portion is bent upward.

In accordance with a fourth aspect of the present invention, the present invention provides a portable charcoal grill that places charcoal on an internal support mesh located at the bottom of the housing thereof, the portable charcoal grill including: an internal support mesh for supporting the charcoal, wherein the internal support mesh has space forming legs that are integrally bent down to both sides of the internal support mesh and forms a charcoal underside space between the internal support mesh and the housing; a charcoal fixing mesh for covering the charcoal, wherein the charcoal fixing mesh has an interval maintaining downward-protruding part bent down for maintaining the interval between the charcoal; and ignition material supporting mesh for supporting ignition material, wherein the ignition material supporting mesh is placed at half of the height of the charcoal underside space by the space forming legs and formed such that its middle portion is bent upward. Here the charcoal fixing mesh places a wire roasting mesh thereon and adjusts the height of the housing.

In accordance with a fifth aspect of the present invention, the present invention a portable charcoal grill that places charcoal on an internal support mesh located at the bottom of the housing thereof, the portable charcoal grill including: an internal support mesh for supporting the charcoal, wherein the internal support mesh has space forming legs that are integrally bent down to both sides of the internal support mesh and forms a charcoal underside space between the internal support mesh and the housing; a charcoal fixing mesh for supporting the charcoal, wherein the charcoal fixing mesh has an internal maintaining upward-protruding part bent up for maintaining the interval between the charcoal; and ignition material supporting mesh for supporting ignition material, wherein the ignition material supporting mesh is placed at half of the height of the charcoal underside space by the space forming legs and formed such that its middle portion is bent upward. Here the charcoal fixing mesh places a wire roasting mesh thereon and adjusts the height of the housing.

### Advantageous Effects

As described above, the present invention has the following advantages.

In accordance with a first aspect of the present invention, since the portable charcoal grill fixes charcoal to the mesh through the through-hole of each charcoal, the charcoal fixing work can be easily performed without any malfunction.

In accordance with a second aspect of the present invention, since the portable charcoal grill fixes the charcoal to the mesh and supports the wire roasting mesh by the pillars each of which is cut as a band-type from the internal support mesh, it does not require any additional charcoal fixing mesh.

In accordance with a third aspect of the present invention, the portable charcoal grill includes an ignition material support mesh that supports the ignition material in a space formed by space forming legs located at both sides of the internal support mesh and has passages for providing outside air above and below the ignition material. Therefore, the ignition material is can be easily ignited and continuously burned. In addition, since the housing forms repeated bent grooves on its side wall at a certain distance, the vertical strength is increased and the storage convenience, the load convenience, and the durability that prevents the deformation are enhanced. Furthermore, since a pushing portion protrudes downward at the center portion of the internal support mesh, it can prevent the ignition material from moving from side to side and thus initial heat concentration and heat evenness are provided.

In accordance with a fourth aspect of the present invention, the portable charcoal grill allows the charcoal fixing mesh to support the wire roasting mesh, thereby reducing the distance between the charcoal fixing mesh and the wire roasting mesh, accordingly reducing the whole height of the grill, and enhancing its mobility and storage convenience.

In accordance with a fifth aspect of the present invention, since the portable charcoal grill places an additional charcoal fixing mesh located above the internal support mesh, in which the charcoal fixing mesh forms interval maintaining upwardly-protruding parts for maintaining the interval between the charcoal and supports the wire roasting mesh, the portable charcoal grill can be easily loaded with charcoal and easily assembled with others.

Also, since the portable charcoal grill includes an ignition material support mesh in an charcoal underside space formed by the space forming legs located at both sides of the internal support mesh so that the ignition support mesh supports the ignition material and has passages for providing outside air above and below the ignition material, the ignition material can be easily ignited and continuously burned.

In addition, since the portable charcoal grill repeatedly forms bent grooves on the side wall of the housing at a certain distance, it can increase the vertical strength of the side wall and thus enhance storage convenience, loading convenience, and durability to prevent structural damage.

Furthermore, since the portable charcoal grill forms a pushing portion that protrudes downwards at the middle portion of the internal support mesh, the pushing portion prevents the ignition material from moving from side to side and thus the ignition material provides initial heat evenness.

### DESCRIPTION OF DRAWINGS

The features and advantages of the present invention will be more apparent from the following detailed description in conjunction with the accompanying drawings, in which:

FIG. 1 is a perspective view depicting a general charcoal grill;

FIG. 2 is a cross-sectional view illustrating the charcoal grill, taken along line A-A, in FIG. 2;

FIG. 3 is a plan view illustrating a conventional charcoal grill;

FIG. 4 is a cross-sectional view illustrating the charcoal grill, taken along line G-G, in FIG. 3;

FIG. 5 is a cross-sectional view illustrating the charcoal grill, taken along line H-H, in FIG. 3;

FIG. 6 is a perspective view depicting a primary part of a first embodiment of the portable charcoal grill according to the present invention;

FIG. 7 is an enlarged cross-sectional view depicting a primary part of the first embodiment of the portable charcoal grill according to the present invention, where the first embodiment is assembled;

FIG. 8 is a cross-sectional view illustrating the first embodiment of the present invention according to the present invention, where the first embodiment is assembled;

FIG. 9 is a perspective view depicting a primary part of a second embodiment of the portable charcoal grill according to the present invention;

FIG. 10 is a cross-sectional view depicting a third embodiment of the portable charcoal grill according to the present invention;

FIG. 11 is a cross-sectional view depicting an exemplary example modified from the third embodiment of FIG. 10;

FIG. 12 is a cross-sectional view depicting a fourth embodiment of the portable charcoal grill according to the present invention;

FIG. 13 is a cross-sectional view depicting an exemplary example modified from the fourth embodiment of FIG. 12;

FIG. 14 is a cross-sectional view depicting a fifth embodiment of the portable charcoal grill according to the present invention; and

FIG. 15 is a cross-sectional view depicting an exemplary example modified from the fifth embodiment of FIG. 14.

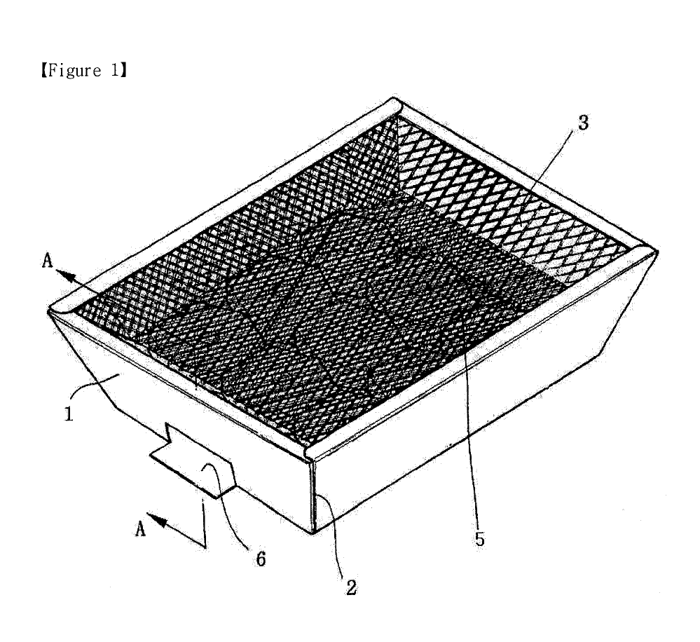

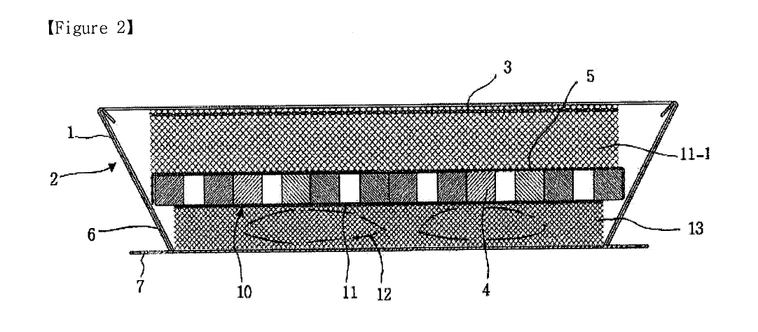

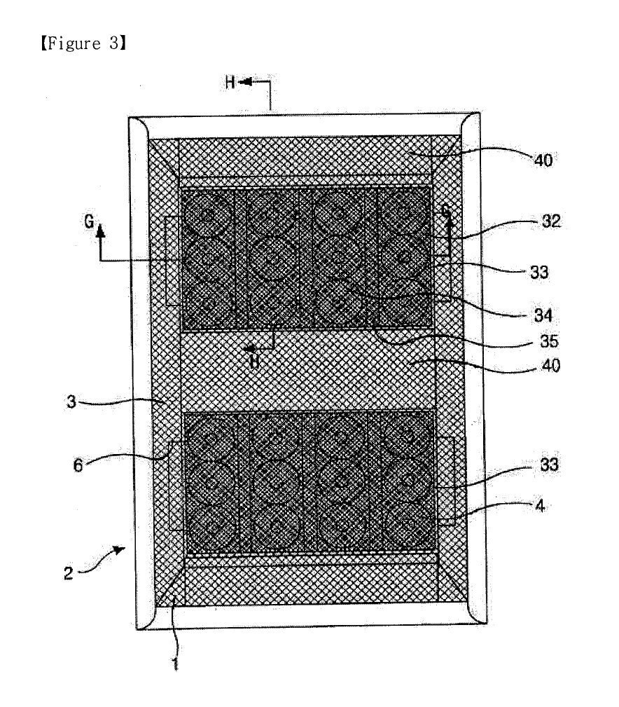

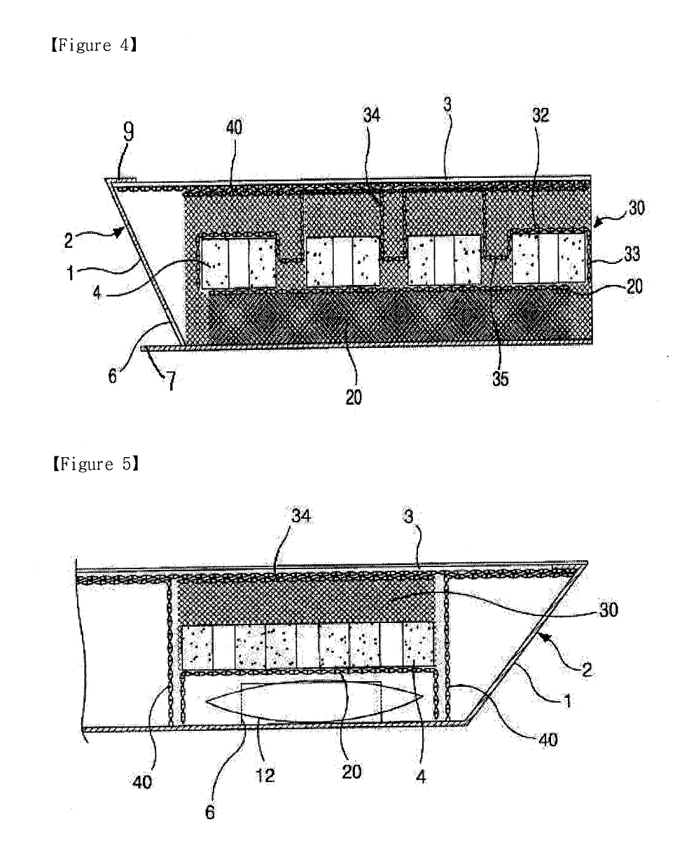

### BRIEF DESCRIPTION OF SYMBOLS IN THE DRAWINGS

1: side wall
2: housing
3: wire roasting mesh
4: charcoal
4-1: through-hole
20: internal support mesh
22: space maintaining part
23: side support part
24: space forming legs
24-1: charcoal underside space
25: pushing portion
30: charcoal fixing mesh
35: interval maintaining downward-protruding part
36: interval maintaining upwardly-protruding part
50: fixing string
51: first string
52: second string
53: middle bent portion
60: support
61: horizontal bar
62: middle bent portion
70: ignition material support mesh
80: bent groove

### BEST MODE

Hereinafter, exemplary embodiments of the present invention are described in detail with reference to the accompanying drawings. The same reference numbers are used throughout the drawings to refer to the same or similar parts. Detailed descriptions of well-known functions and structures incorporated herein may be omitted to avoid obscuring the subject matter of the present invention.

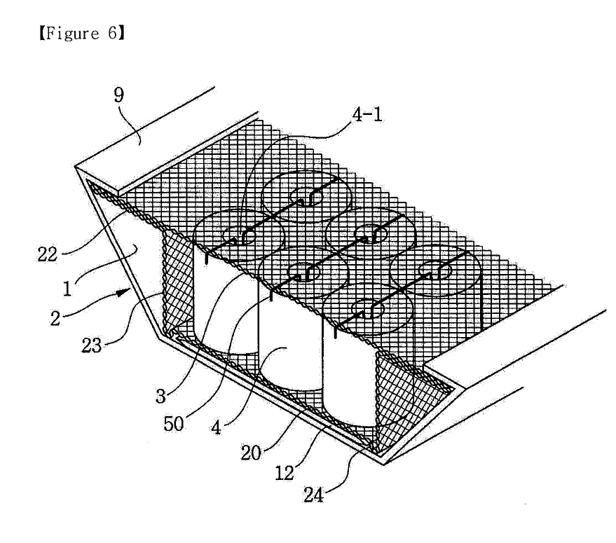

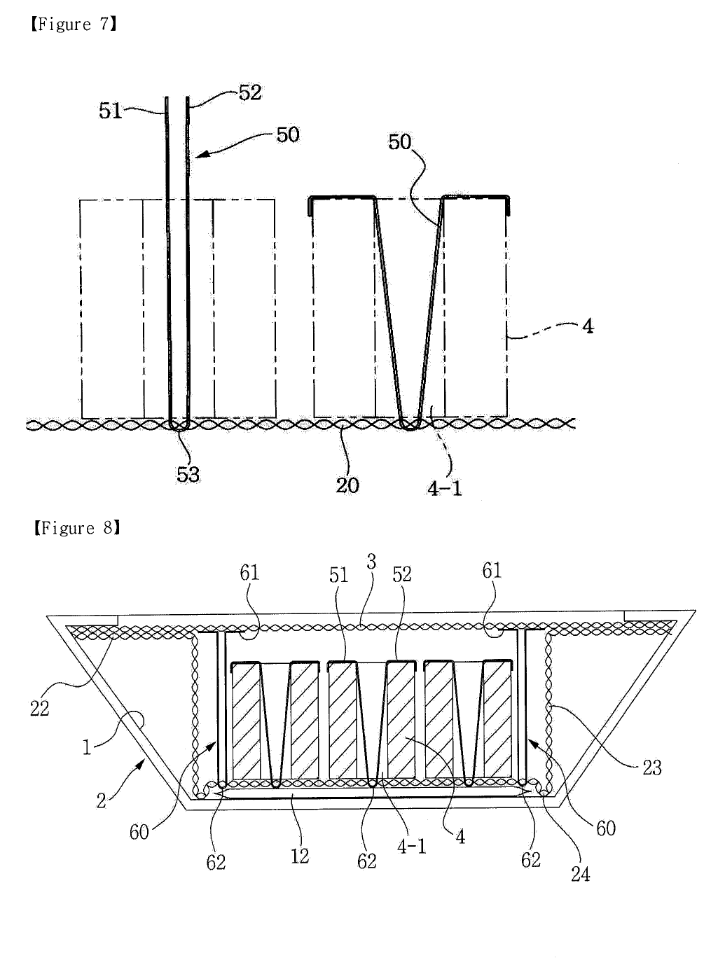

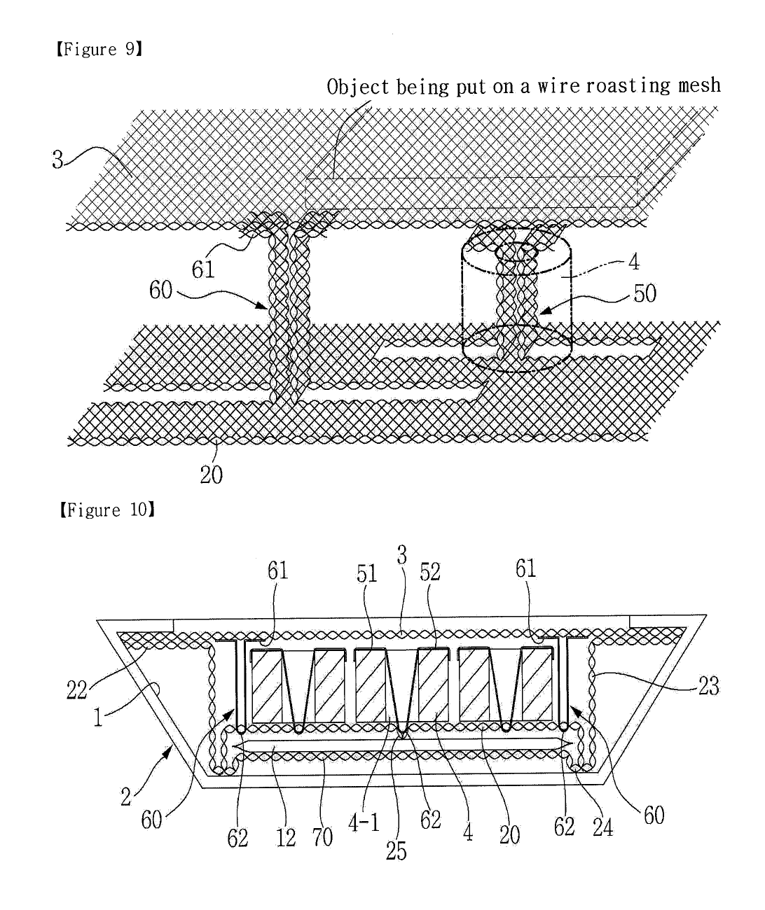

FIG. 6 is a perspective view depicting a primary part of a first embodiment of the portable charcoal grill according to the present invention. FIG. 7 is an enlarged cross-sectional view depicting a primary part of the first embodiment of the portable charcoal grill according to the present invention, where the first embodiment is assembled. FIG. 8 is a cross-sectional view illustrating the first embodiment of the present invention according to the present invention, where the first embodiment is assembled. FIG. 9 is a perspective view depicting a primary part of a second embodiment of the portable charcoal grill according to the present invention.

The portable charcoal grill, according to the present invention, places charcoal on an internal support mesh located at the bottom of the housing thereof. The portable charcoal grill includes: a fixing string 50 having a certain length whose lower end forms a middle bent portion 53 that is vertically fitted into part of the internal support mesh 20 at which the charcoal is placed, and whose upper end is widened to fix the charcoal; charcoal 4 each of which has a through-hole 4-1 through which the fixing string 50 is extended and has a height such that the fixing string 50 protrudes from top thereof; and a wire roasting mesh 3 placed on the fixed charcoal 4.

The internal support mesh 20 includes: a side support part 23 that is bent at the ends of the portion holding up the charcoal 4 and blocks the sides of the charcoal located close to the ends; and interval maintaining parts 22, located at the upper end of the side support part 23, for maintaining a certain interval between the side support 23 and a side wall or other side support parts.

The portable charcoal grill, according to the present invention, further includes space forming legs 24 for forming a space between the side support part 23 and the portion holding up the charcoal 4 of the internal support mesh 20. An ignition material is fitted into the space and the space forming legs 24 extend downwards.

The fixing string 50 has a certain length and is bent at the middle length thereof, so that the middle bent portion 53 is formed at the middle length of the fixing string 50 and a first string 51 and a second string 52 are formed with respect to the middle bent portion 53. The first and second strings 50 and 51 are inserted into the through-hole 4-1 of the charcoal 4 and both upper ends of the first and second strings 50 and 51 are bent to secure the upper end of the charcoal 4.

The portable charcoal grill, according to the present invention, further includes at least four vertical bar-type pillars 60, whose lower ends are fixed to the internal support mesh 20, for supporting the wire roasting mesh 3. The vertical bar-type pillars 60 form a space between the upper end of the charcoal and the wire roasting mesh 3.

The vertical bar-type pillars form a horizontal bar 61 at their upper end to support the wire roasting mesh 3. The lower end of each of the vertical bar-type pillars 60 is spot-welded or bound to the internal support mesh. Each pillar 60 has a middle bent portion 62 that is fixed to the internal support mesh 20 by a wire. As shown in FIG. 9, the internal support 20 is processed to form a pillar 60 and a fixing string 50 as parts of the internal support 20 are cut as a band-type and vertically bent upwards to match the interval of the arrangement of the charcoal. The upper end of the pillar 60 forms a horizontal bar 61 to receive the weight of the wire roasting mesh 3. The horizontal bar 61 can be integrally formed with the pillar 60. In addition, the horizontal bar 61 may be individually manufactured and then coupled to the pillar 60.

As shown in FIGS. 6 and 7, the middle bent portion 53 of the fixing string 50 is fixed into the internal support mesh 20 at which the charcoal is placed. Fixing the middle bent portion 53 to the internal bent support mesh 20 is performed by a welding method, a bonding method, or an additional wire. Also, the middle bent portion 53 can be fixed to the internal middle bent portion 53 in such a way that it is twisted and turned. The first and second strings 51 and 52 of the fixed fixing string 50 are extended through the hole of the charcoal 4 as shown in the left diagram of FIG. 7.

After that, the first and second strings 51 and 52 are widened at and then bent over the upper end of the charcoal 4 to fix it. The first and second strings 51 and 52 may be bent to cover the outer side of the charcoal 4 as occasion demands. The fixing string 50 including the first and second strings 51 and 52 is made of various materials, such as iron or aluminum.

That is, the upper end of the charcoal 4 is fixed by the first and second strings 51 and 52 of the fixing string 50 whose lower end (middle bent portion 53) is fixed to the internal support mesh 20, and thus the charcoal 4 is tightly fixed and placed on the internal support mesh 20. Therefore, the portable charcoal grill of the present invention does not require any additional fixing mesh.

Also, the portable charcoal grill of the present invention does not need an additional space maintaining mesh, which makes it possible to reduce the height and width of the grill. Therefore, the freight charge and storage fee for the portable charcoal grill can be reduced and the grill provides a convenient operating method for users. However, it can exert the same function as a conventional grill.

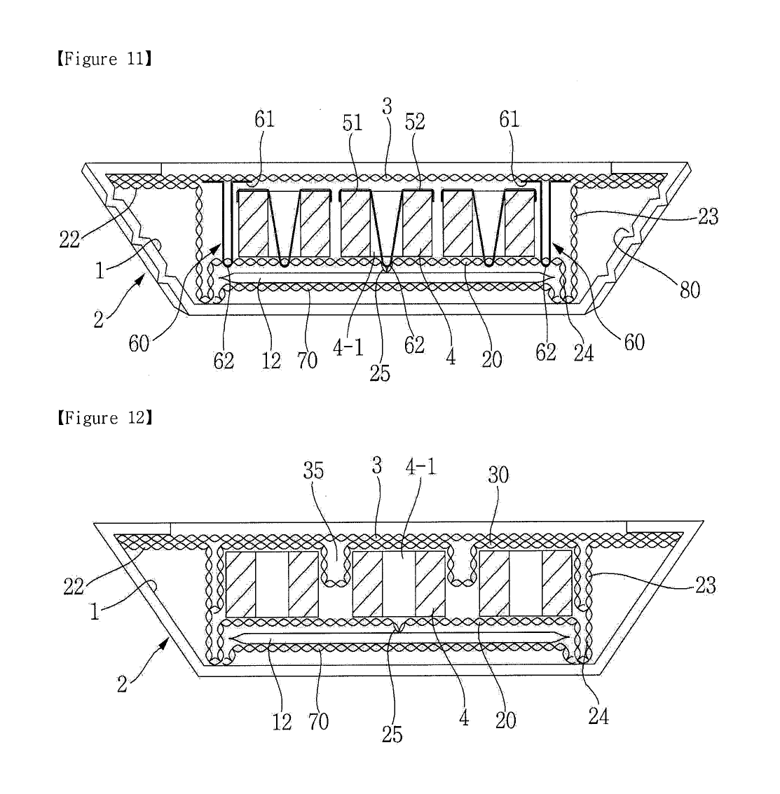

FIG. 10 is a cross-sectional view depicting a third embodiment of the portable charcoal grill according to the present invention. FIG. 11 is a cross-sectional view depicting an exemplary example modified from the third embodiment of FIG. 10.

As shown in FIGS. 10 and 11, the third embodiment of the portable charcoal grill is configured in such a way that an internal support mesh is placed on the bottom of the housing and supports the charcoal. Like the first embodiment, the third embodiment has also the fixing string 50, charcoal 4 and wire roasting mesh 3.

The third embodiment includes: space forming legs 24 for forming a charcoal underside space 24-1 between the internal support mesh 20 and the bottom of the housing; and ignition material support mesh 70 for supporting ignition material 12. The space forming legs 24 are integrally formed with the internal support mesh 20 as both ends of the internal support mesh 20 are bent down. The ignition material support mesh 70 is located at half the height of the charcoal underside space 24-1 and curved upwards at its center portion. The ignition material support mesh 70 may be formed to include: an ignition material support portion at the center thereof; and leg-type bent portions having a certain height at both sides thereof. The ignition material support portion may be formed to have an upward-protruding form, i.e., an embossed shape, and thus may provide different heights to form a space between the bottom side and the ignition material support portion. The position of the embossed shape is altered according to the ignition material size.

The housing 2 forms bent grooves 80 for receiving a vertical weight on the side wall 1 at a certain distance.

Since the third embodiment is the same as the first embodiment in terms of the method for fixing the charcoal 4 on the internal support mesh 20 using the fixing string 50, its detail operation is omitted in the following description except for the function of other elements. The ignition material support mesh 70 is formed in such a way that its center portion protrudes upwards to be located at half the height of the charcoal underside space 24-1, in which the charcoal underside space 24-1 is formed by the space forming legs 24 between the internal support mesh 20 and the bottom of the housing. The ignition material support mesh 70 supports the ignition material 12 so that there is air circulating around the ignition material 12, i.e., there is as space above and below the ignition material 12. Therefore, the ignition material 12 can be easily ignited, thereby reducing the ignition time, and it does not extinguish during burning.

The housing 2 forms bent grooves 80 for receiving a vertical weight on the side wall 1 at a certain interval, so that the housing 2 can maintain its original form when objects to be roasted are loaded or roasted. The internal support mesh 20 forms a pushing portion 25 that protrudes downwards at the center thereof. The pushing portion 25 maintains charcoal at a certain location, so that the charcoal can be evenly ignited.

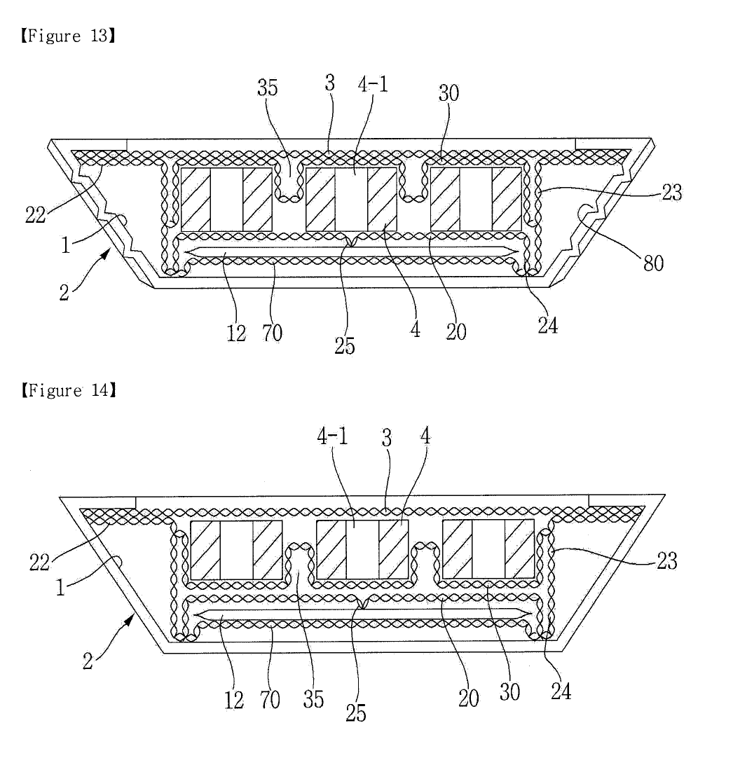

FIG. 12 is a cross-sectional view depicting a fourth embodiment of the portable charcoal grill according to the present invention. FIG. 13 is a cross-sectional view depicting an exemplary example modified from the fourth embodiment of FIG. 12.

As shown in FIGS. 12 and 13, the fourth embodiment of the portable charcoal grill is configured in such a way that an internal support mesh is placed on the bottom of the housing and supports the charcoal. Like the third embodiment, the fourth embodiment has also the internal support mesh 20 and the ignition material support mesh 70.

The fourth embodiment is configured to include a charcoal fixing mesh 30 that covers charcoal 4. The charcoal fixing mesh 30 is formed in such a way that interval maintaining downward-protruding parts 35 are bent down to separate and maintain an interval between the charcoal 4. The wire roasting mesh 3 is placed on the charcoal fixing mesh 30. This structure reduces the height of the housing of the fourth embodiment.

The housing 2 forms bent grooves 80 for receiving a vertical weight on the side wall 1 at a certain distance.

Since the fourth embodiment is configured in such a way that the wire roasting mesh 3 is placed on the charcoal fixing mesh 30 that covers charcoal 4, it can reduce its entire height while also increasing the load amount of charcoal. Therefore, the fourth embodiment can reduce the freight charge and storage fee of the grill.

Also, since the ignition material support mesh 70 is located under the internal support mesh 20 so that the ignition material 12 placed on the ignition material support mesh 70 is located at the middle of the height between the bottom of the housing 2 and the internal support mesh 20, the ignition material 12 is completely burned by air circulating above and below the ignition material 12, thereby increase the burning efficiency. That is, the ignition material 12 is not extinguished when it is lit and provides even heat to the object to be roasted.

The internal support mesh 20 forms a pushing portion 25 that protrudes downwards at the center thereof. The pushing portion 25 maintains charcoal at a certain location, so that the charcoal can be evenly ignited.

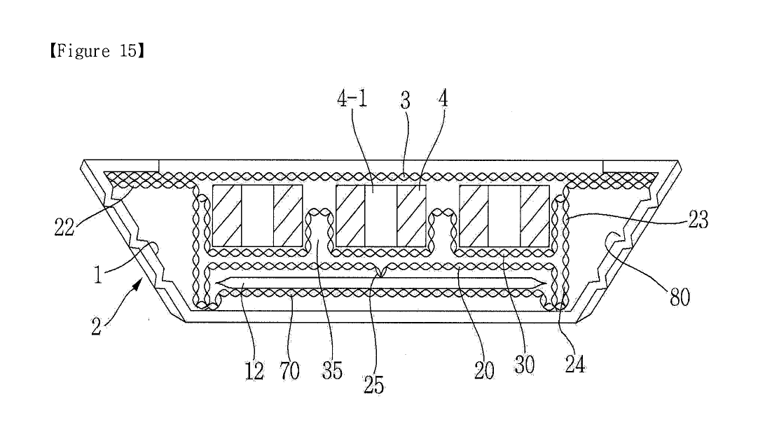

FIG. 14 is a cross-sectional view depicting a fifth embodiment of the portable charcoal grill according to the present invention. FIG. 15 is a cross-sectional view depicting an exemplary example modified from the fifth embodiment of FIG. 14.

As show in FIGS. 14 and 15, the fifth embodiment of the portable charcoal grill is configured in such a way that an internal support mesh is placed on the bottom of the housing and supports the charcoal. The fourth embodiment includes the same elements as the fourth embodiment and further includes a charcoal fixing mesh 30 that supports charcoal 4. The charcoal fixing mesh 30 is formed in such a way that interval maintaining upward-protruding parts 36 are bent upwards to separate and maintain an interval between the charcoal 4.

Since the fourth embodiment is configured in such a way to place the charcoal 4 loaded with the charcoal fixing mesh 30 on the internal support mesh 20, it is easy to assemble the elements. Also, since the wire roasting mesh 3 is directly placed on the charcoal fixing mesh 30, the entire height of the fourth embodiment is decreased and thus the freight fee and storage fee can also be reduced.

Also, since the ignition material support mesh 70 is located under the internal support mesh 20 so that the ignition material 12 placed on the ignition material support mesh 70 is located at the middle of the height between the bottom of the housing 2 and the internal support mesh 20, the ignition material 12 is completely burn by air circulating above and below the ignition material 12, thereby increase the burning efficiency. That is, the ignition material 12 is not extinguished when it is lit and provides even heat to the object to be roasted.

The internal support mesh 20 forms a pushing portion 25 that protrudes downwards at the center thereof. The pushing portion 25 maintains charcoal at a certain location, so that the charcoal can be evenly ignited.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A portable charcoal grill that places charcoal on an internal support mesh located at the bottom of the housing thereof, the portable charcoal grill comprising:
a fixing string having a certain length whose lower end forms a middle bent portion that is vertically fitted into part of the internal support mesh at which the charcoal is placed, and whose upper end is widened to fix the charcoal;
charcoal each of which has a top, sides and a through-hole through which the fixing string is extended and a height such that the fixing string protrudes from the top thereof; and a wire roasting mesh placed on the charcoal.

2. The grill according to claim 1, wherein the internal support mesh comprises:
a side support part having an upper end, the side support part being bent at the ends of a portion holding up the charcoal and adapted to block the sides of the charcoal;
and interval maintaining parts, located at the upper end of the side support part, for maintaining a certain interval between the side support and a side wall or other side support parts.

3. The grill according to claim 2, further comprising space forming legs to provide a space between the side support part and the portion holding up the charcoal of the internal support mesh, wherein an ignition material is fitted into the space and the space forming legs extend downwards.

4. The grill according to claim 1, wherein:
the fixing string has a certain length and is bent at the middle length thereof, so that the middle bent portion is formed at the middle length of the fixing string and a first string and a second string are formed with respect to the middle bent portion;
and the first and second strings are inserted into the through-hole of the charcoal and both upper ends of the first and second stings are bent to secure the upper end of the charcoal.

5. The grill according to claim 1, further comprising at least four vertical bar-type pillars, whose lower ends are fixed to the internal support mesh, for supporting the wire roasting mesh, wherein the vertical bar-type pillars form a space between the upper end of the charcoal and the wire roasting mesh.

6. The grill according to claim 5, wherein the vertical bar-type pillars form a horizontal bar at their upper end to support the wire roasting mesh.

7. A portable charcoal grill that places charcoal on an internal support mesh located at the bottom of the housing thereof, the portable charcoal grill comprising:
a fixing string having a certain length, whose lower end is cut as a band-shape and vertically bent at a place of the internal support mesh, and whose upper end is horizontally bent to fix the charcoal;
charcoal each of which has a through-hole through which the fixing string is extended and has a height such that the fixing string is protruded from the top thereof; and a wire roasting mesh placed on the fixed charcoal.

8. The grill according to claim 7, further comprising at least four pillars a portion of each which is vertically bent as a band shape, wherein each of the pillars has a horizontal bar, bent at the upper end thereof, for supporting the wire roasting mesh.

9. A portable charcoal grill that places charcoal on an internal support mesh located at the bottom of the housing thereof, the portable charcoal grill comprising:
a fixing string having a certain length whose lower end forms a middle bent portion that is vertically fitted into a part of the internal support mesh at which the charcoal is placed, and whose upper end is widened to fix the charcoal;
charcoal each of which has a through-hole through which the fixing string is extended and has a height such that the fixing string is protruded from the top thereof; a wire roasting mesh placed on the fixed charcoal;
space forming legs, integrally bent down to both sides of the internal support mesh, for generating a charcoal underside space between the internal support mesh and the bottom of the housing; and ignition material supporting mesh for supporting ignition material, wherein the ignition material supporting mesh is placed at half of the height of the charcoal underside space by the space forming legs and formed such that its middle portion is bent upward.

10. The grill according to claim 1, wherein the housing forms bent grooves up on side walls thereof, wherein the bent grooves are aligned upwards at a certain distance from each other and receive a vertical weight.

11. A portable charcoal grill that places charcoal on an internal support mesh located at the bottom of the housing thereof, the portable charcoal grill comprising:
an internal support mesh for supporting the charcoal, wherein the internal support mesh has space forming legs that are integrally bent down to both sides of the internal support mesh and forms a charcoal underside space between the internal support mesh and the housing;
a charcoal fixing mesh for covering the charcoal, wherein the charcoal fixing mesh has an interval maintaining downward-protruding part bent down for maintaining the interval between the charcoal;
and ignition material supporting mesh for supporting ignition material, wherein the ignition material supporting mesh is placed at half of the height of the charcoal underside space by the space forming legs and formed such that its middle portion is bent upward, wherein the charcoal fixing mesh places a wire roasting mesh thereon and adjusts the height of the housing.

12. The grill according to claim 11, wherein the housing (2) forms bent grooves (80) on side walls (1) thereof, wherein the bent grooves (80) are aligned upward at a certain distance from each other and receive a vertical weight.

13. A portable charcoal grill that places charcoal on an internal support mesh located at the bottom of the housing thereof, the portable charcoal grill comprising:
an internal support mesh for supporting the charcoal, wherein the internal support mesh has space forming legs that are integrally bent down to both sides of the internal support mesh and forms a charcoal underside space between the internal support mesh and the housing;
a charcoal fixing mesh for supporting the charcoal, wherein the charcoal fixing mesh has an interval maintaining upward-protrudent part bent up for maintaining the interval between the charcoal;
and ignition material supporting mesh for supporting ignition material, wherein the ignition material supporting mesh is placed at half of the height of the charcoal underside space by the space forming legs and formed such that its middle portion is bent upward, wherein the charcoal fixing mesh places a wire roasting mesh thereon and adjusts the height of the housing.

14. The grill according to claim 13, wherein the housing forms bent grooves on side walls thereof, wherein the bent grooves are aligned upward at a certain distance from each other and receive a vertical weight.

15. The grill according to claim 10, wherein the bent grooves are arranged in one of a horizontal direction, a vertical direction or in a checkerboard pattern.

16. The grill according to claim 1, wherein the internal support mesh forms a pressing part at the center on the lower side thereof, in which the pushing portion prevents the horizontal movement of the ignition material.

17. A portable charcoal grill, comprising:
a housing adapted to contain a plurality of charcoal members;
a support mesh associated with said housing and for holding charcoal;
a fixing string having a certain length and having a lower end, an upper end and
a middle portion, the middle portion vertically connected to the support mesh;
a plurality of charcoal members each having a top, a bottom and a through-hole extending from the top to the bottom, the fixing string extending through the through-hole of each of the plurality of charcoal members and protruding from the top of each of the plurality of charcoal members; and
a wire roasting mesh placed over the plurality of charcoal members.
